(19) United States
(12) Patent Application Publication
(10) Pub. No.: US 2010/0080089 A1
(43) Pub. Date: Apr. 1, 2010

(54) Storage medium reproducing apparatus or storage medium recording/reproducing apparatus

(75) Inventor: Kouji Azai, Echizen-shi (JP)

Correspondence Address: Juan Carlos A. Marquez;c/o Stites & Harbison PLLC, 1199 North Fairfax Street, Suite 900, Alexandria, VA, 22314-1437, US

(73) Assignee: Orion Electric Company Ltd.

(21) Appl. No.: 12/585,876

(22) Filed: Sep. 28, 2009

(30) Foreign Application Priority Data
Sep. 29, 2008 (JP) 2008-249540

(51) Int. Cl. G11B 13/00

(52) U.S. Cl. 369/14; G9B/13

(57) ABSTRACT

In a recording/reproducing apparatus, a pair of detection sliders, in which pins coming into contact with an outer peripheral edge of a storage medium being inserted are formed and which approach and are separated from each other, are disposed in the vicinity of a storage medium insert port, and a detection lever coupled with one of the pins is rotatably and slidably attached to a frame. Further, the recording/reproducing apparatus has a support member, which is slid by being pressed by the outer peripheral edge of the storage medium being inserted, and an intermediate guide lever rotated in association with a sliding operation of the support member. Two select grooves are formed in the detection lever, and a first projecting piece, which is selectively fit into the select grooves, is disposed in the intermediate guide lever.

### BACKGROUND OF THE INVENTION

1. Field of the Invention

The present invention relates to a storage medium reproducing apparatus or a storage medium recording/reproducing apparatus of a so-called slot-in system having a storage medium insert port (hereinafter, simply called an insert port) which permits a disk-shaped storage medium (hereinafter, simply called a storage medium) to be directly inserted and extracted. More particularly, the present invention relates to a storage medium reproducing apparatus or a storage medium recording/reproducing apparatus which handles storage media having different diameters and can mechanically discriminate whether a storage medium inserted from an insert port is a large-diameter storage medium or a small-diameter storage medium, guide the storage medium to a predetermined position in the apparatus, and securely clamp the storage medium by a turntable and a damper at the predetermined position.

2. Description of the Related Art

Explanation will be continued below generically calling the storage medium reproducing apparatus or the storage medium recording/reproducing apparatus in the present invention as a recording/reproducing apparatus or simply as an apparatus.

The recording/reproducing apparatus is an apparatus which can carry a storage medium into the apparatus and read and reproduce previously stored information or write and record information to the carried storage medium. In the recording/reproducing apparatus, a system for carrying the storage medium is roughly classified into a tray system and a slot-in system. In the tray system, the storage medium can be carried to a predetermined position in the apparatus by placing the storage medium on a carry tray which can linearly reciprocate between in the apparatus and outside thereof. Further, since the carry tray has a large-diameter storage medium placing portion and a small-diameter storage medium placing portion with a step formed therebetween, there is almost no case where a storage medium carried into the apparatus is positionally offset in the apparatus and cannot be clamped by a turntable and a damper. In other words, when the storage medium is placed in conformity with any one of the placing portions formed on the carry tray, the storage medium can be properly carried to the predetermined position in the apparatus together with the carry tray.

In contrast, in the recording/reproducing apparatus of the slot-in system, the storage medium is inserted from a storage medium insert port formed in a frame acting as an exterior of the apparatus, and the inserted storage medium is carried into the apparatus by a carrying mechanism disposed in the vicinity of the storage medium insert port. Note that, in the recording/reproducing apparatus of the slot-in system, a means for discriminating a size of a storage medium to be inserted is necessary. More specifically, the apparatus must be provided with a means for detecting whether a storage medium being inserted is a large-diameter storage medium or a small-diameter storage medium and securely carrying the storage medium to a predetermined position inside the apparatus. Otherwise, the discriminating means becomes unnecessary by permitting only one kind of a storage medium to be inserted, in which case there is additionally required a means for prohibiting insertion of other kinds of a storage medium.

Incidentally, various techniques have been conventionally known as to the recording/reproducing apparatus of the slot-in system which handles storage media having different diameters. In “a slot-in type disk apparatus” according to, for example, Japanese Patent Application Laid-Open No. 2006-172557, a disk drive means is commonly used as that of a tray type disk apparatus and a disk carrying operation and an optical pick-up operation are executed by a single motor. Then, the disk apparatus can mechanically accurately discriminate two types of disks having different sizes.

Thus, a carrying roller as a disk carrying means is combined with a disk drive means having an optical pick-up and the like. Power of a motor is selectively transmitted to a first pinion and the carrying roller by a gear train. A large-size disk and a small-size disk are discriminated by a selector lever. A slider is collectively provided with a cam mechanism for controlling operations of a disk stopper, a pinion/rack mechanism, and the like.

“A disk reproducing apparatus” according to Japanese Patent Application Laid-Open No. 2003-346406 is a disk reproducing apparatus for preventing occurrence of a faulty operation by securely returning a slide member to a position of origin. More specifically, when a disk size select lever is rotated in a direction of an arrow A by an eject operation of a disk, a press surface of the select lever presses a corner portion of a first slider rack placed in a movement impossible state toward a direction of an arrow C. When the disk is completely ejected, the disk size select lever is returned in a direction of an arrow B by an urging force of a coil spring while the first slider rack operates so as to be forcibly returned to the position of origin by the urging force of the coil spring.

Although there are many types of techniques as to the recording/reproducing apparatus of the slot-in system handling storage media having different diameters in addition to the above-described techniques, almost all the discriminating mechanisms of these known recording/reproducing apparatuses have many parts or employ a relatively expensive electric means such as a sensor, and have such a structure that it is difficult to suppress their complexity and an increase of their cost.

As described above, many of the conventional recording/reproducing apparatuses of the slot-in system have a complex discrimination means for discriminating a size of a storage medium being inserted. Thus, a subject to be solved by the present invention resides in the above problems, and the present invention provides a recording/reproducing apparatus of a slot-in system having a discriminating mechanism of storage media which is mechanically configured using a necessary minimum number of parts without using electrical detecting parts at all as a means for discriminating a size of a storage medium being inserted. Further, the recording/reproducing apparatus of the slot-in system is a recording/reproducing apparatus of a slot-in system configured such that an inserted storage medium is securely clamped by a turntable and a damper at a predetermined position in the apparatus.

### SUMMARY OF THE INVENTION

In a recording/reproducing apparatus of a slot-in system according to the present invention, a storage medium insert port is disposed in a frame acting as an exterior of the apparatus, and a carrying roller is disposed orthogonal to an insert direction of a disk-shaped storage medium inserted from the storage medium insert port. The recording/reproducing apparatus, which carries the storage medium inserted thereinto by driving the carrying roller in rotation, has a traverse unit to which a turntable for lifting up the storage medium at a predetermined position in the apparatus is attached as its main component and a damper disposed at a position confronting the turntable for clamping the storage medium together with the turntable.

Further, the recording/reproducing apparatus has a discriminating mechanism for mechanically discriminating whether a storage medium being inserted is a large-diameter storage medium or a small-diameter storage medium and introducing the discriminated storage medium to a predetermined position in the apparatus. The discriminating mechanism is mainly composed of a pair of detection sliders, which have a pair of pins coming into contact with an outer peripheral edge of a storage medium being inserted in the vicinity of the storage medium insert port and in which the pair of pins slides in a direction toward or away from each other along the outer peripheral edge of the storage medium, a detection lever which rotates in association with the sliding operation of the detection sliders, a support member which slides in an insert direction together with the storage medium while in contact with the outer peripheral edge thereof, and an intermediate guide lever which rotates in association with the sliding operation of the support member.

The detection lever is rotatably and slidably attached to a frame while two select grooves are formed in the detection lever, and a first projecting piece, which can be selectively fit into the select grooves, is formed in the intermediate guide lever. More specifically, the first projecting piece is fit into any of the select grooves according to amounts of rotation of the detection lever and the intermediate guide lever and slides the intermediate guide lever. In other words, the detection lever and the intermediate guide lever have different amounts of rotation depending on a diameter of a storage medium being inserted, and to describe this in more detail, the amounts of rotation are changed depending on amounts of movement of the pins, which are in contact with the outer peripheral edge of the storage medium, and the support member.

Further, a slider, which can slide approximately in parallel with the insert direction of the storage medium, is attached to the frame, and a rack gear and a slide cam groove are formed in the slider. The rack gear is disposed so as to be meshed with a pinion gear rotated by power of a drive motor to thereby slide the slider by the power of the drive motor. A second projecting piece, which is separately formed in the detection lever, is loosely fit into the slide cam groove. The slider, which is placed in a coupling state by the second projecting piece and the slide cam groove before the rack gear is meshed with the pinion gear, is slightly slid by an operation of the detection lever which is rotated and slid by inserting the disk. As a result, the rack gear is meshed with the pinion gear. After the rack gear is meshed with the pinion gear, the second projecting piece moves along the slide cam grooves, and the detection lever is rotated.

Further, two select guide grooves are formed in the slider and a third projecting piece is formed in the intermediate guide lever so that the third projecting piece is selectively fit into the select guide grooves according to a size of a storage medium being inserted and the sliding operation of the slider. When the third projecting piece is fit into any of the two select guide grooves formed in the slider according to the size of the storage medium, the intermediate guide lever is rotated through the third projecting piece, and when the insertion of the storage medium is completed, the support member is separated from the outer peripheral edge of the storage medium by the rotation of the intermediate guide lever.

In the recording/reproducing apparatus according to the present invention, a means for discriminating whether a storage medium being inserted is a large-diameter storage medium or a small-diameter storage medium is configured without using an electrical detecting unit. More specifically, the discriminating mechanism of the storage medium is mainly composed of the pair of detection sliders having pins, the detection lever which is operated in association with the operation of the detection sliders, the support member which is slid by being pressed by the storage medium being inserted, and the intermediate guide lever which is rotated in association with the operation of the support member. The mechanical discriminating mechanism of the storage medium is realized as a structure which is configured such that the first projecting piece formed in the intermediate guide lever can be selectively fit into the two select grooves formed in the detection lever. As a result, since the discriminating mechanism of the recording/reproducing apparatus can be configured by a necessary minimum number of parts, and a less expensive recording/reproducing apparatus can be provided.

As to a timing when the rack gear, which is formed in the slider, is meshed with the pinion gear, which is rotated by the power of the drive motor, by the discriminating mechanism of the storage medium, since the second projecting piece formed in the detection lever changes a timing when the slider is slid through the slide cam groove, a storage medium being inserted can be securely clamped by the turntable and the damper at a predetermined position by discriminating a size thereof. Further, after completion of clamping of the storage medium at the predetermined position of the recording/reproducing apparatus, a separating operation of the support member can be executed by forcibly rotating the intermediate guide lever by selectively fitting the third projecting piece formed in the intermediate guide lever into the select guide grooves formed in the slider.

### BRIEF DESCRIPTION OF THE DRAWINGS

FIG. 1 is an outside perspective view showing a recording/reproducing apparatus in an embodiment;

FIG. 2 is a schematic transparent plan view showing a state that a large-diameter storage medium is partly inserted into a storage medium insert port of the recording/reproducing apparatus;

FIG. 3 is a schematic transparent plan view showing a state that the large-diameter storage medium is further inserted into the apparatus than the state of FIG. 2;

FIG. 4 is a schematic transparent plan view showing a state that about a half of the large-diameter storage medium is carried into the apparatus;

FIG. 5 is a schematic transparent plan view showing a state that the large-diameter storage medium is further inserted into the apparatus than the state of FIG. 4;

FIG. 6 is a schematic transparent plan view showing a state that the large-diameter storage medium is further inserted into the apparatus than the state of FIG. 5;

FIG. 7 is a schematic transparent plan view showing a state that the large-diameter storage medium is carried to a predetermined position in the apparatus;

FIG. 8 is a schematic transparent plan view showing a state that a slider and a speed reduction gear mechanism are added to FIG. 6 as components;

FIG. 9 is a schematic transparent plan view showing a state that a rack gear of a slider is meshed with a gear as a detection lever moves;

FIG. 10 is a schematic transparent plan view showing a state that the slider completes an operation of sliding to a rear side of the recording/reproducing apparatus;

FIG. 11 is a schematic transparent plan view showing a state that a small-diameter storage medium is partly inserted into a storage medium insert port of the recording/reproducing apparatus;

FIG. 12 is a schematic transparent plan view showing a state that the small-diameter storage medium is further inserted into the apparatus than the state of FIG. 11;

FIG. 13 is a schematic transparent plan view showing a state that the small-diameter storage medium is further inserted into the apparatus than the state of FIG. 12;

FIG. 14 is a schematic transparent plan view showing a state that the small-diameter storage medium is further inserted into the apparatus than the state of FIG. 13;

FIG. 15 is a schematic transparent plan view showing a state that an outer peripheral edge of the small-diameter storage medium comes into contact with a support member, and the support member is slightly pressed and moved rearward as the small-diameter storage medium is carried and moved;

FIG. 16 is an internal longitudinal sectional view showing the vicinity of the storage medium insert port of the recording/reproducing apparatus in the embodiment;

FIG. 17 is an internal longitudinal sectional view showing a state that the large-diameter storage medium is lifted up by a turntable at a predetermined position in the recording/reproducing apparatus;

FIG. 18 is a schematic transparent plan view showing a state that the large-diameter storage medium and the small-diameter storage medium are partly inserted from the storage medium insert port; and

FIG. 19 is a perspective view showing a specific shape of a pressing member in the embodiment.

### DESCRIPTION OF THE PREFERRED EMBODIMENTS

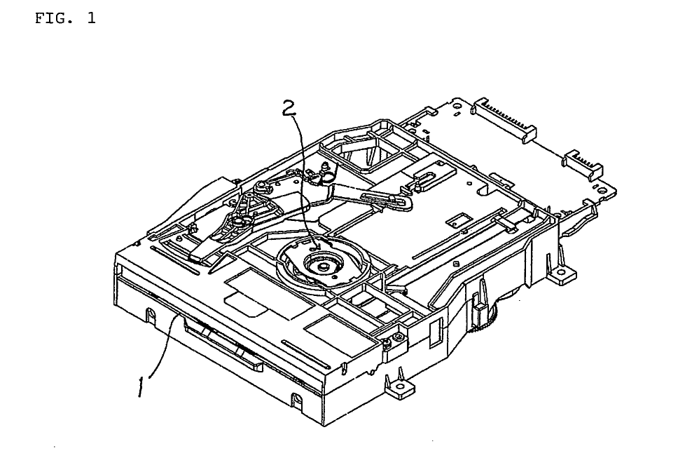

Embodiments as best modes for carrying out the present invention will be explained below referring to FIGS. 1 to 19. The present invention may, however, be applied in other modes than explained below in reference to the accompanying drawings, without departing from the scope and gist of the present invention.

FIG. 1 is an outside perspective view showing a recording/reproducing apparatus in the embodiment. Reference numeral 1 of FIG. 1 denotes a storage medium insert port through which a storage medium can be inserted and ejected, and 2 denotes a damper suspension unit for rotatably suspending a damper for clamping a storage medium carried into the apparatus together with a turntable at a predetermined position. Note that the storage medium in the embodiment is an approximately disk-shaped medium in which an audio signal and/or a video signal is recorded or in which the above signals can be recorded, and the storage medium is called CD, DVD, a disk, or the like. Further, the storage medium includes a large-diameter storage medium having a diameter of about 120 mm and a small-diameter storage medium having a diameter of about 80 mm. A carrying mechanism in the apparatus is operated by inserting the storage medium from the storage medium insert port 1, and the storage medium is carried to a predetermined position. At this time, the recording/reproducing apparatus has such a structure that a center of a storage medium being inserted reaches the predetermined position in the apparatus and is securely clamped by the turntable and the damper regardless of whether the storage medium is a large-diameter storage medium or a small-diameter storage medium.

Since the recording/reproducing apparatus of the present invention employs a slot-in system, it has a carrying roller disposed in the vicinity of the storage medium insert port 1. The carrying roller extends in a direction orthogonal to an insert direction of the storage medium and comes into contact with the vicinity of an outer peripheral edge of the storage medium from one surface side thereof. To describe the carrying roller in the embodiment in more detail, it is formed in a taper shape whose diameter is reduced toward a center from both ends thereof and comes into contact with the storage medium from a recording surface side thereof. With the above configuration, even if the taper-shaped carrying roller comes into contact with the storage medium being inserted from the recording surface side thereof, the roller comes into contact with the storage medium in the vicinity of the outer peripheral edge thereof at all times. Therefore, the storage medium can be carried into the apparatus without being scratched on its recording surface. Further, since the storage medium insert port 1 is formed in a size allowing the large-diameter storage medium to be inserted thereinto, when the small-diameter storage medium is inserted, it is considered that the small-diameter storage medium is offset from a center of the storage medium insert port 1. However, since the carrying roller is formed in the taper shape so that the diameter thereof is reduced from both the ends toward the center, even if the small-diameter storage medium is inserted while being offset from the center of the storage medium insert port 1, the storage medium can be carried to the predetermined position while being moved toward a central position without being scratched on its recording surface.

A gear is attached to one end of the carrying roller and rotated by power of a drive motor disposed in the vicinity thereof. A worm gear is attached to a shaft of the drive motor, and the carrying roller is driven in rotation by the power transmitted from the worm gear to the carrying roller through a speed reduction gear mechanism. Note that the power of the drive motor is also used as power for moving a slider to be described later in addition to the rotation of the carrying roller. The speed reduction gear mechanism described above is not particularly limited as long as it has a configuration capable of properly transmitting power to the carrying roller and the slider which will be described later.

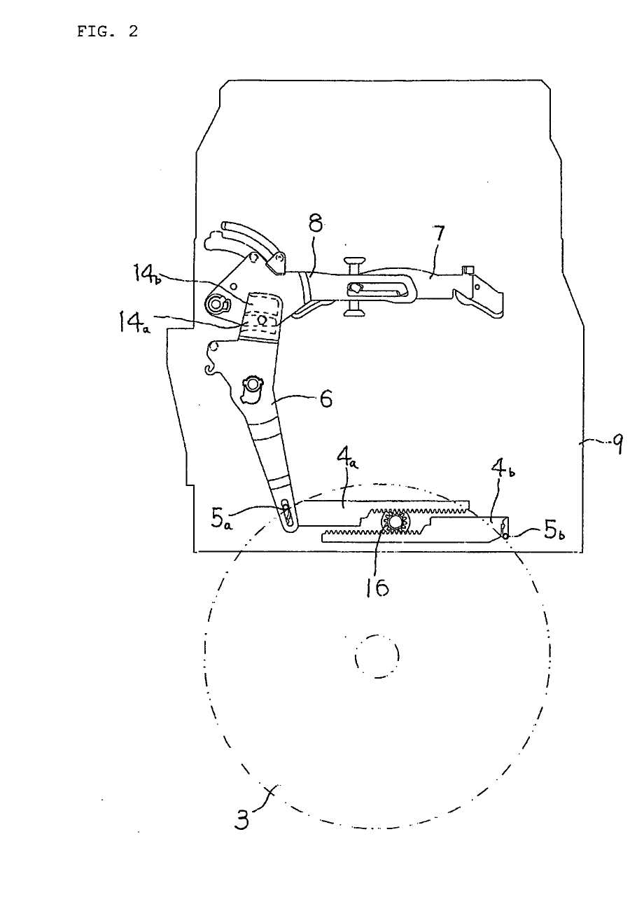

Next, an operation when the storage medium is inserted from the storage medium insert port 1 of the recording/reproducing apparatus will be explained. FIG. 2 is a schematic transparent plan view showing a state that the large-diameter storage medium 3 is partly inserted into the storage medium insert port 1 of the recording/reproducing apparatus. Reference numerals 4a, 4b in FIG. 2 denote detection sliders for detecting insertion/ejection of the storage medium, 5a, 5b denote pins which are formed integrally with the detection sliders and come into contact with the outer peripheral edge of the storage medium being inserted and ejected, 6 denotes a detection lever, 7 denotes a support member with which the outer peripheral edge of the storage medium comes into contact at a rear position in the apparatus, 8 denotes an intermediate guide lever, and 9 denotes a frame acting as an exterior of the apparatus. The detection sliders 4a, 4b are assembled so that they can slide in a right-to-left direction along a guide portion (not shown) disposed in the frame 9. When the outer peripheral edge of the large-diameter storage medium being inserted comes into contact with the pins 5a, 5b formed integrally with the detection sliders 4a, 4b, both the pins 5a, 5b are pressed in a direction away from each other, and the sliders 4a, 4b slide in an outer direction (right-to-left direction in the figure).

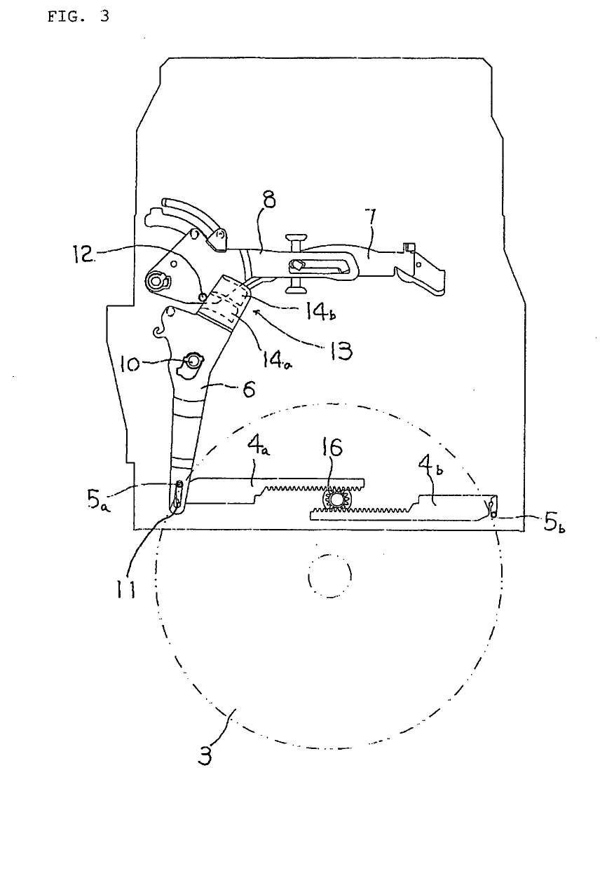

FIG. 3 is a schematic transparent plan view showing a state that the large-diameter storage medium 3 is further inserted into the apparatus than the state of FIG. 2. The detection sliders 4a, 4b slide in the outer direction together with the pins 5a, 5b coming into contact with the outer peripheral edge of the large-diameter storage medium 3 and, at the same time, the detection lever 6 which is coupled with the pin 5a rotates clockwise about a shaft 10 as a fulcrum. To describe a rotation structure of the detection lever 6 in more detail, the detection slider 4a is coupled with the detection lever 6 in a state that the pin 5a formed integrally with the detection slider 4a is loosely fit into a long groove 11 formed in an extreme end of the detection lever 6, and the pin 5a is pressed by the outer peripheral edge of the large-diameter storage medium 3 and the detection slider 4a slides in a left outer direction while the detection lever 6, which is coupled with the detection slider 4a by the loosely fit pin 5a, can rotate clockwise about the shaft 10 as the fulcrum.

The intermediate guide lever 8 is rotatably disposed in the back side of the detection lever 6, and a first projecting piece 12 is formed in the intermediate guide lever 8 integrally therewith. Further, a pair of select grooves 14a, 14b, into which the first projecting piece 12 can be inserted, is formed in the other end 13 of the detection lever 6. Before the large-diameter storage medium 3 is inserted and the detection lever 6 rotates clockwise, the first projecting piece 12 is loosely fit into the select groove 14a positioned on the shaft 10 side as shown in FIG. 2. When the large-diameter storage medium 3 is further inserted as shown in FIG. 3, the detection lever 6 rotates clockwise about the shaft 10 as the fulcrum, and the first projecting piece 12 of the intermediate guide lever 8 is removed from the select groove 14a formed on a lower side of the other end 13 of the detection lever 6.

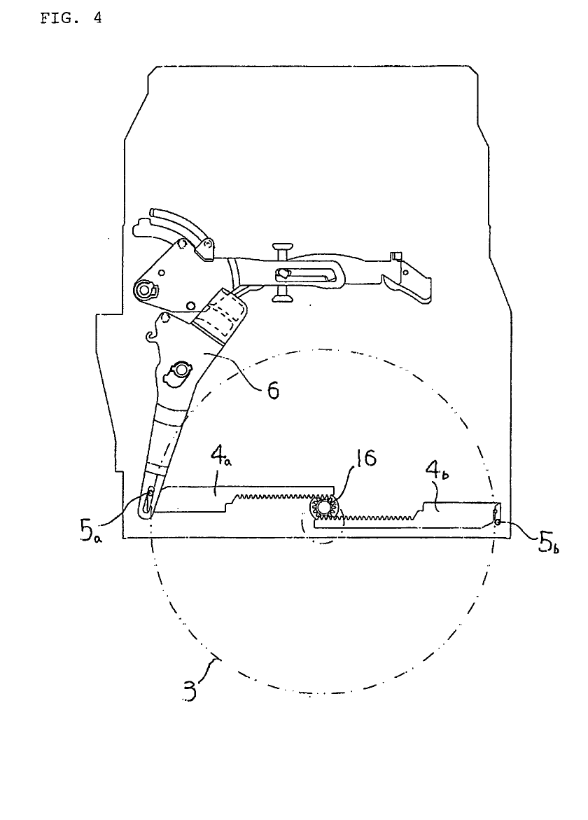

FIG. 4 is a schematic transparent plan view showing a state that about a half of the large-diameter storage medium 3 is carried into the apparatus. When the large-diameter storage medium 3 is further inserted into the apparatus from the state of FIG. 3, the detection sliders 4a, 4b slide in the outer direction together with the pins 5a, 5b which come into contact with the outer peripheral edge of the large-diameter storage medium 3 and, at the same time, the detection lever 6 further rotates clockwise about the shaft 10 as the fulcrum.

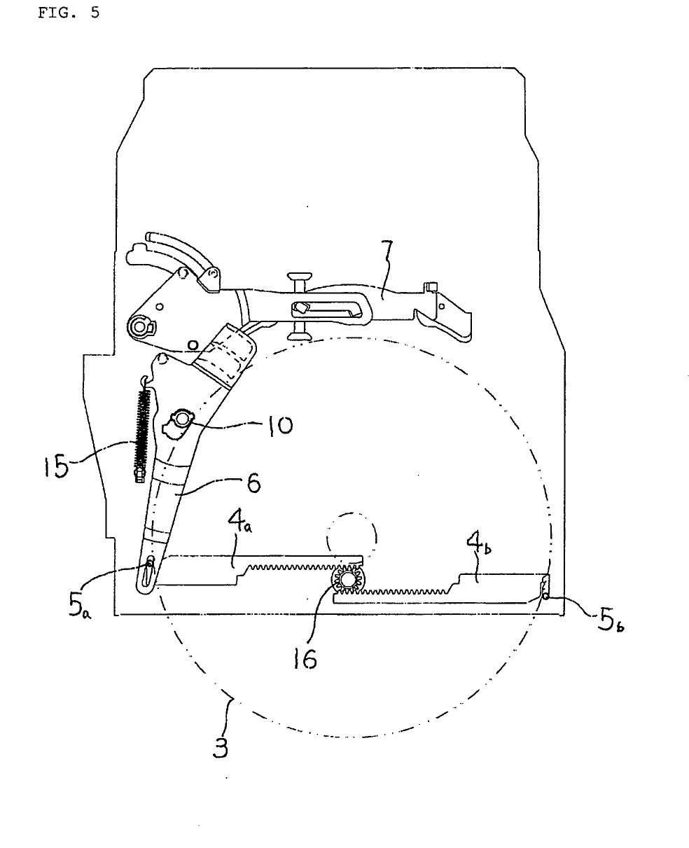

FIG. 5 is a schematic transparent plan view showing a state that the large-diameter storage medium 3 is further inserted into the apparatus than the state of FIG. 4. In this state, the detection sliders 4a, 4b are slightly returned in a direction toward each other. An urging force is always applied in a direction where the detection sliders 4a, 4b approach each other, and a distance between the pins 5a, 5b, which come into contact with the outer peripheral edge of the storage medium, is increased up to a diameter of the storage medium being inserted as its maximum interval against the urging force so that the pins 5a, 5b are separated from each other. As a result, when more than half of the large-diameter storage medium 3 is inserted, the distance between the pins 5a, 5b, which come into contact with the outer peripheral edge of the large-diameter storage medium 3, is decreased, and the detection sliders 4a, 4b, which slide in the outer direction, are returned by the urging force of the detection sliders 4a, 4b. In the embodiment, a structure having a coil spring 15 coupled with the detection lever 6 is employed as an example for generating the urging force. Torque is applied by the coil spring 15 to rotate the detection lever 6 counterclockwise, the detection slider 4a coupled with the detection lever 6 is slid in an inner direction by the urging force, and, at the same time, the detection slider 4b meshed through a pinion gear 16 is also slid inward.

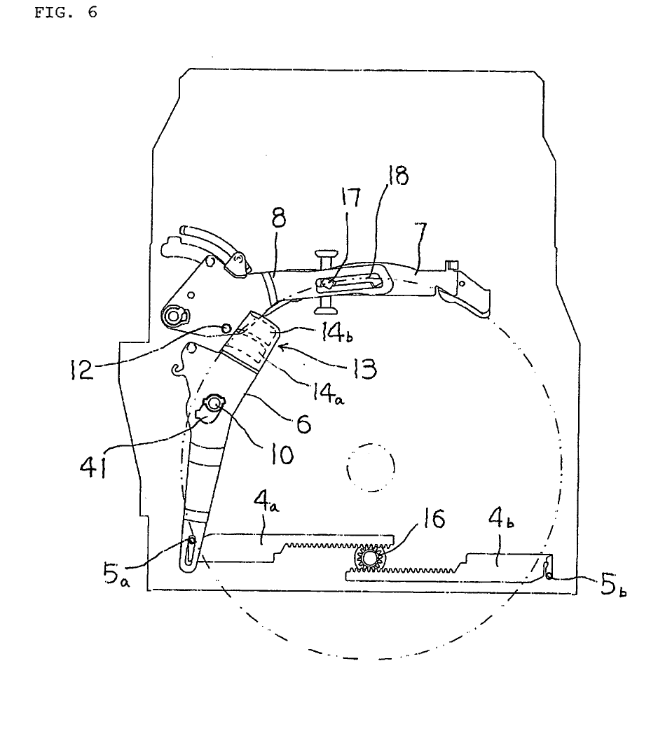

FIG. 6 is a schematic transparent plan view showing a state that the large-diameter storage medium 3 is further inserted into the apparatus than the state of FIG. 5. The detection lever 6 rotates counterclockwise about the shaft 10 as the fulcrum while the detection sliders 4a, 4b slide in the inner direction where they approach each other. When the large-diameter storage medium 3 is carried in by the carrying roller, the outer peripheral edge of the large-diameter storage medium 3 comes into contact with the support member 7 disposed at a rear position in the apparatus, and the support member 7 is moved to a rear side of the apparatus by a carrying operation of the large-diameter storage medium 3 that acts as a pressing force. Note that an urging force also acts on the support member 7 so that it can return to a position as a reference position before the outer peripheral edge of the large-diameter storage medium 3 comes into contact with the support member 7 at all times. The support member 7 is moved to the rear side of the apparatus by the pressing force of the large-diameter storage medium 3 which is carried against the urging force.

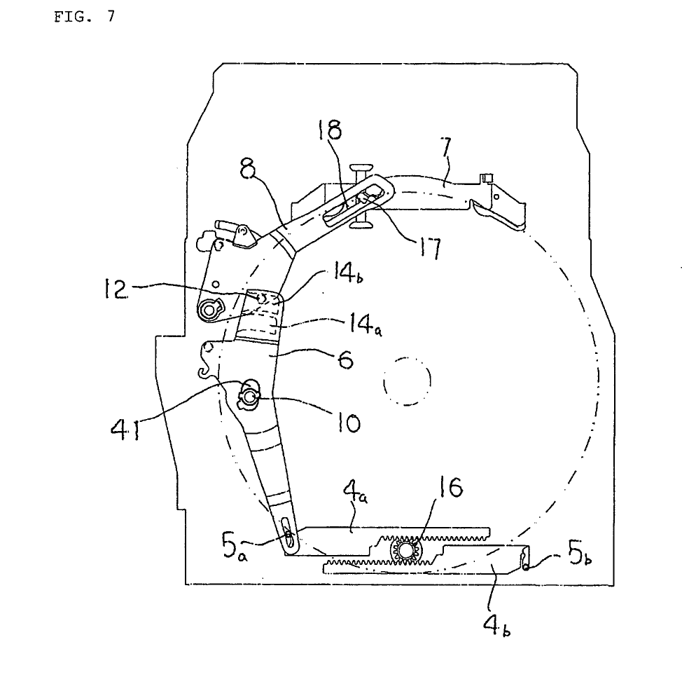

FIG. 7 is a schematic transparent plan view showing a state that the large-diameter storage medium 3 is carried into a predetermined position in the apparatus. As shown in FIG. 6, when the outer peripheral edge of the large-diameter storage medium 3 comes into contact with the support member 7 on its rear side and further the large-diameter storage medium 3 is carried in by the carrying roller, the support member 7 is pressed by the large-diameter storage medium 3 and moved to the rear side of the apparatus to thereby rotate the intermediate guide lever 8 counterclockwise. The detection lever 6 is further rotated counterclockwise by the urging force of the coil spring 15, and the first projecting piece 12, which is raised from the intermediate guide lever 8, is loosely fit into the select groove 14b.

Before the large-diameter storage medium 3 is inserted into the recording/reproducing apparatus, the first projecting piece 12 of the intermediate guide lever 8 is loosely fit into the select groove 14a formed in the lower side of the other end 13 of the detection lever 6 as shown in FIG. 2. When the support member 7 is pressed by the outer peripheral edge of the large-diameter storage medium 3 carried into the apparatus and is moved rearward and the intermediate guide lever 8 coupled with the support member 7 is rotated counterclockwise in association with the movement of the support member 7, a position of the first projecting piece 12 is changed. The pins 5a, 5b of the detection sliders 4a, 4b slide in a direction toward each other while coming into contact with the outer peripheral edge of the large-diameter storage medium 3 in the state that the position of the first projecting piece 12 is changed, the detection lever 6 coupled with the pin 5a of the detection slider 4a is rotated counterclockwise about the shaft 10 as the fulcrum by the urging force of the coil spring 15, and the first projecting piece 12 of the intermediate guide lever 8 is loosely fit into the select groove 14b formed in an upper side of the other end 13 of the detection lever 6. The large-diameter storage medium 3 is further carried into the apparatus in the state that the first projecting piece 12 of the intermediate guide lever 8 is loosely fit into the select groove 14b of the detection lever 6, the support member 7 is moved rearward by the carrying operation of the large-diameter storage medium 3, and the intermediate guide lever 8 is further rotated counterclockwise by the movement of the support member 7. Since the first projecting piece 12 of the intermediate guide lever 8 is loosely fit into the select groove 14b of the detection lever 6, the first projecting piece 12 moves the detection lever 6 rearward through the select groove 14b. Note that, to allow the rearward movement of the detection lever 6, a portion into which the shaft 10 acting as the fulcrum is fit is formed in a slot shape (hereinafter, called a slot 41), and the shaft 10 is loosely fit into the slot 41.

An example of a coupling structure for coupling the support member 7 with the intermediate guide lever 8 will be explained in more detail. When a pin 17 raised from the support member 7 is loosely fit into a guide groove 18 formed in an end of the intermediate guide lever 8 and the support member 7 is pressed by the large-diameter storage medium 3 and moved rearward, the pin 17 can move along the guide groove 18 into which the pin 17 is loosely fit and the intermediate guide lever 8 can rotate counterclockwise about the shaft acting as a fulcrum.

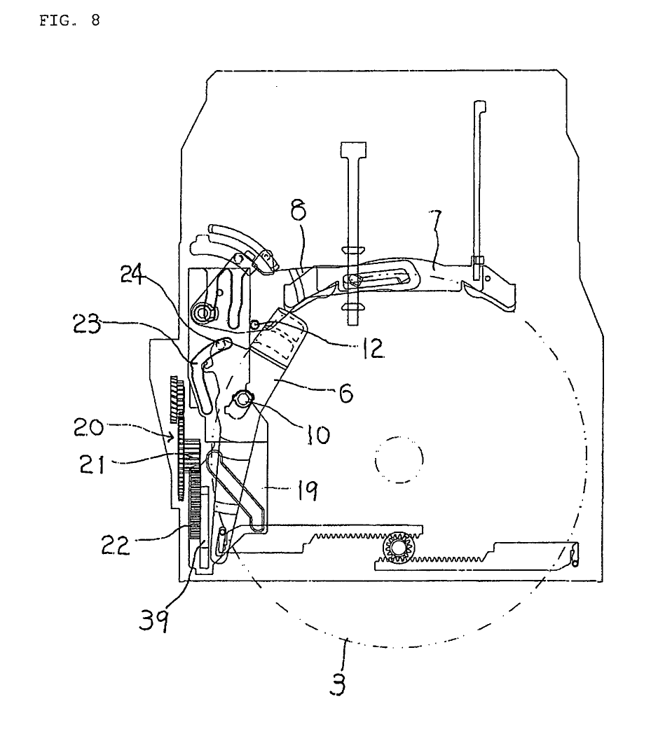

FIG. 8 is a schematic transparent plan view showing a state that a slider 19 and a speed reduction gear mechanism 20 are added to FIG. 6 as components. That is, the slider 19 is attached to the recording/reproducing apparatus of the present invention so that it can slide in a direction approximately in parallel with the insert direction of the large-diameter storage medium 3, and the slider 19 can clamp the large-diameter storage medium 3 at the predetermined position in the apparatus by the turntable and the damper in association with the detection lever 6, the support member 7, and the intermediate guide lever 8. Likewise, when a small-diameter storage medium is inserted, the slider 19 discriminates it from the large-diameter storage medium 3 and can carry it into the predetermined position and clamp and fix it by the turntable and the damper at the predetermined position.

The speed reduction gear mechanism 20 rotates by obtaining power from a drive motor (not shown), a gear 21 is directly coupled with the carrying roller, and the large-diameter storage medium 3 is carried into the apparatus by the rotation of the gear 21. A rack gear 22 disposed in the slider 19 is not meshed with the gear 21 in a state of FIG. 8. However, when the slider 19 slightly moves rearward, the rack gear 22 is meshed with the gear 21, and the slider 19 can be slid by the power of the drive motor.

The slider 19 has a slide cam groove 23 curved in an approximately arc shape, and a second projecting piece 24, which is disposed downward from the detection lever 6, is loosely fit into the slide cam groove 23. When the detection lever 6 rotates about the shaft 10, the second projecting piece 24 can move along the slide cam groove 23. When the outer peripheral edge of the large-diameter storage medium 3 on its rear side comes into contact with the support member 7 and the support member 7 moves rearward together with the large-diameter storage medium 3, the intermediate guide lever 8 is rotated to move the detection lever 6 rearward through the select groove 14b into which the first projecting piece 12 is loosely fit. As a result, the second projecting piece 24, which is loosely fit into the slide cam groove 23, slightly moves the slider 19 rearward, and the rack gear 22 disposed in the slider 19 is meshed with the gear 21.

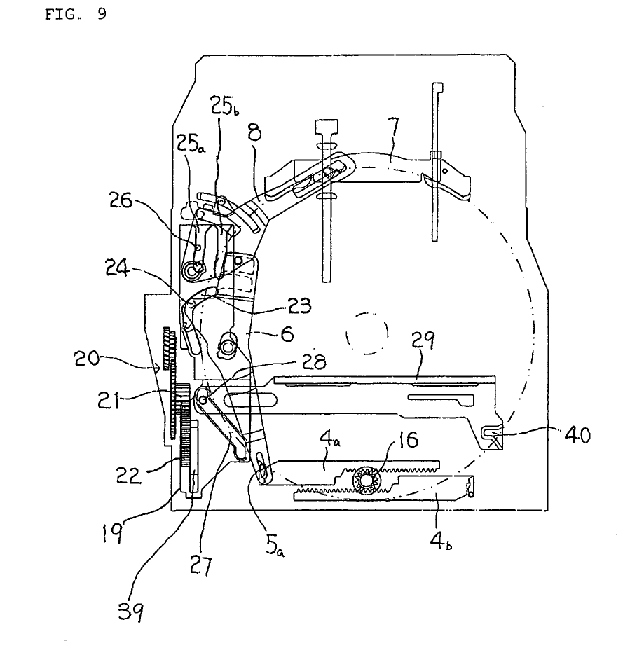

FIG. 9 is a schematic transparent plan view showing a state that the rack gear 22 of the slider 19 is meshed with the gear 21 as the detection lever 6 moves. When the gear 21, which is rotated by the power of the drive motor, is meshed with the rack gear 22, the slider 19 can be slid to the rear side of the apparatus. The gear 21 is a part of the speed reduction gear mechanism 20 and transmits a rotation force to the carrying roller for carrying in and out the large-diameter storage medium 3. When the rack gear 22 of the slider 19 is meshed with the gear 21, the slider 19 is moved by the power of the drive motor.

Incidentally, a guide groove 27 is formed in the slider 19, and a fourth projecting piece 28, which is formed in a lateral slider 29 disposed in the frame 9 approximately orthogonal to the slider 19, is loosely fit into the guide groove 27. More specifically, since the fourth projecting piece 28, which is loosely fit into the guide groove 27, is moved by a sliding operation of the slider 19, the lateral slider 29, in which the fourth projecting piece 28 is formed, is slid by the movement of the slider 19. The embodiment has such a structure that a traverse unit, which has the turntable and a pick-up unit as main components, can be tilted in association with the sliding operation of the lateral slider 29. More specifically, the lateral slider 29 moves in association with the slider 19 being slid to the rear side of the recording/reproducing apparatus by the power of the drive motor at the time the large-diameter storage medium 3 reaches a predetermined position in the recording/reproducing apparatus, and the traverse unit begins to tilt from a tilt state to a horizontal state in association with the operation of the lateral slider 29. Then, the large-diameter storage medium 3 can be lifted up from a recording surface side thereof by the turntable of the traverse unit and can be clamped together with the damper disposed at a position confronting the turntable. At this time, although the large-diameter storage medium 3 is separated from the carrying roller, the pin 5 and the support member 7 remain in contact with the outer peripheral edge of the large-diameter storage medium 3.

Next, a structure in which the pin 5 and the support member 7, which are in contact with the outer peripheral edge of the large-diameter storage medium 3, are separated therefrom will be explained. When the slider 19 moves to the rear side of the recording/reproducing apparatus, the second projecting piece 24 moves along the slide cam groove 23, and the detection lever 6, in which the second projecting piece 24 is formed, slightly rotates clockwise about the shaft 10 as the fulcrum against the urging force of the coil spring 15. Then, as the detection lever 6 rotates, the detection slider 4a moves in a direction away from the outer peripheral edge of the large-diameter storage medium 3 together with the pin 5a loosely fit into the long groove 11, and the detection slider 4b, which is coupled with the detection slider 4a through the pinion gear 16, is moved in a direction away from the detection slider 4a.

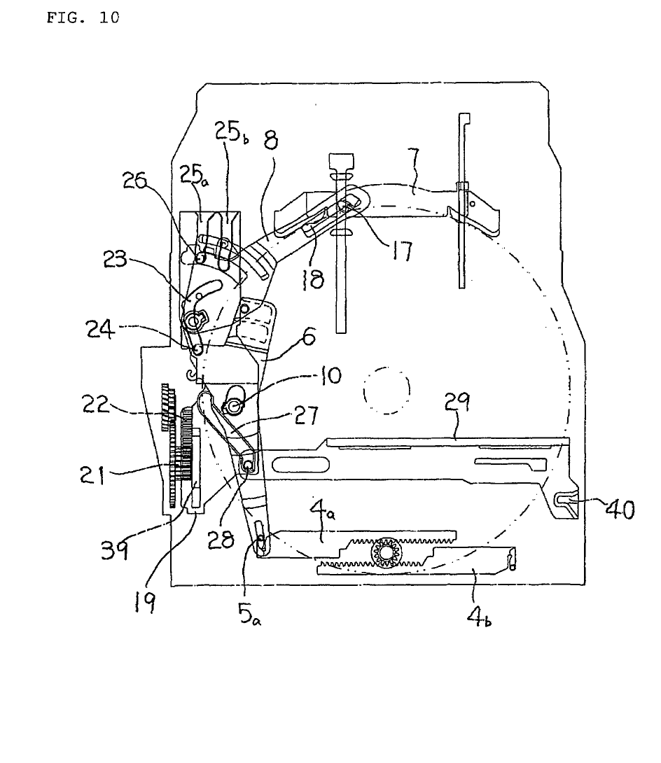

A timing, at which the support member 7 is separated from the outer peripheral edge of the large-diameter storage medium 3, is also determined by the movement of the slider 19. More specifically, two select guide grooves 25a, 25b are formed in a rear end of the slider 19, and a third projecting piece 26, which is loosely fit into the select guide grooves 25a, 25b selectively, is formed in the intermediate guide lever 8 integrally therewith. As described above, since the intermediate guide lever 8 is coupled with the support member 7, when the large-diameter storage medium 3 is inserted, the third projecting piece 26 formed in the intermediate guide lever 8 is loosely fit into the select guide groove 25a by the movement of the slider 19. The loosely fit third projecting piece 26 moves together with the slider 19 in a state that it is fit into the select guide groove 25a, and the intermediate guide lever 8, in which the third projecting piece 26 is formed, rotates counterclockwise about the shaft as the fulcrum. When the intermediate guide lever 8 rotates, the support member 7 can move in a direction away from the outer peripheral edge of the large-diameter storage medium 3. FIG. 10 is a schematic transparent plan view showing a state that the slider 19 has completed an operation of sliding to the rear side of the recording/reproducing apparatus. The slider 19 moves to the rear side until the second projecting piece 24 is positioned at a front end of the slide cam groove 23.

Incidentally, the slide cam groove 23 is not formed in parallel with a sliding direction of the slider 19 but formed in a curved shape. Accordingly, the detection lever 6 can slightly rotate clockwise about the shaft 10 as the fulcrum through the second projecting piece 24 loosely fit into the slide cam groove 23 as well as can move the pin 5a, which is loosely fit into the long groove 11 disposed in the front end of the detection lever 6, in a direction away from the outer peripheral edge of the large-diameter storage medium 3.

In contrast, when, for example, the large-diameter storage medium 3 is inserted, the slider 19 moves to the rear side of the recording/reproducing apparatus, and the third projecting piece 26, which can be loosely fit selectively into the select guide grooves 25a, 25b disposed in the rear end of the slider 19, is loosely fit into the select guide groove 25a. When the slider 19 is further slid, the third projecting piece 26, which reaches a groove bottom of the select guide groove 25a, is moved rearward with the result that the intermediate guide lever 8 is rotated counterclockwise about the shaft as the fulcrum. Since the guide groove 18 is formed in the extreme end of the intermediate guide lever 8, and the pin 17, which is formed by being raised from the support member 7, is loosely fit into the guide groove 18, the support member 7 is moved rearward by the rotation of the intermediate guide lever 8, and the support member 7 is separated from the outer peripheral edge of the large-diameter storage medium 3.

Further, the guide groove 27, which is formed in the slider 19 and into which the fourth projecting piece 28 formed in the lateral slider 19 is loosely fit, is formed in such a shape that end portions, which are located at different positions and formed approximately in parallel with the sliding direction of the slider 19, are coupled with each other obliquely. The fourth projecting piece 28 of the lateral slider 29 is positioned at an outer rear end of the guide groove 27 as shown in FIG. 9 until the rack gear 22 formed in the slider 19 is meshed with the gear 21. However, when the rack gear 22 is meshed with the gear 21 and the slider 19 begins to move to the rear side of the recording/reproducing apparatus, the fourth projecting piece 28 finally moves to an inner front end of the guide groove 27 along a tilt portion as shown in FIG. 10.

Accordingly, the lateral slider 29 slides in a right direction along the guide portion in association with the movement of the slider 19. A guide groove (not shown) is formed in the lateral slider 29, one end of a traverse unit (not shown), which has a pick-up unit and a turntable as its main components, is used as a tilt fulcrum by being coupled with the frame 9 constituting an exterior of the recording/reproducing apparatus, and a projection projecting from an extreme end of the other end of the traverse unit is loosely fit into a guide groove of the lateral slider 29. Accordingly, the traverse unit, which is in a tilt state about the one end as the fulcrum before the large-diameter storage medium 3 is inserted into the recording/reproducing apparatus, tilts so as to be placed in an approximately horizontal state by that the projection of the traverse unit, which is loosely fit into the guide groove of the lateral slider 29, is moved by a slide operation of the slider 19 caused by inserting the large-diameter storage medium 3 and a slide operation of the lateral slider 29 in association with the movement of the slider 19. Then, the turntable attached to the traverse unit is moved up from the recording surface side of the large-diameter storage medium 3 located at the predetermined position in the recording/reproducing apparatus by a tilt motion of the traverse unit and lifts up the large-diameter storage medium 3 so that the large-diameter storage medium 3 is clamped together with the damper suspended by the damper suspension unit 2.

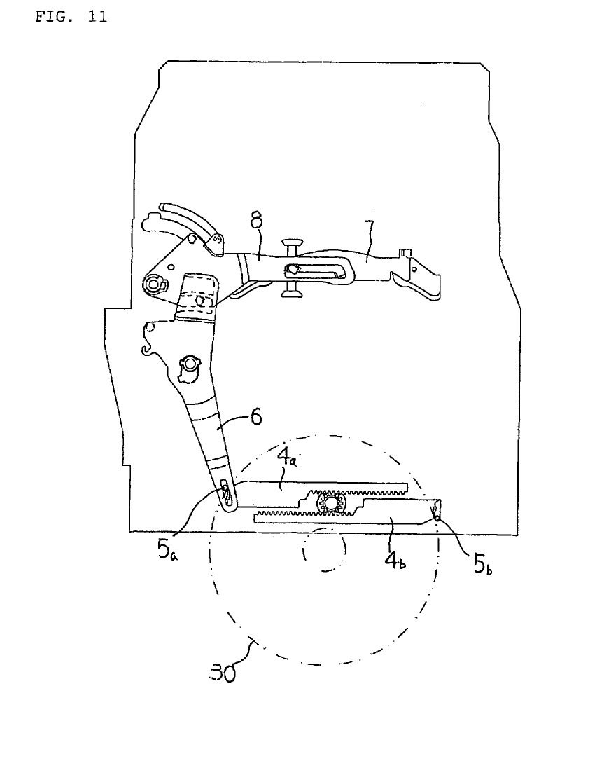

FIGS. 11 to 15 are schematic transparent plan views showing respective steps when a small-diameter storage medium 30 is inserted from the storage medium insert port 1. FIG. 11 is a schematic transparent plan view showing a state that the small-diameter storage medium 30 is partly inserted into the storage medium insert port 1 of the recording/reproducing apparatus. In FIG. 11, reference numerals 4a, 4b denote the detection sliders, 5a, 5b denote the pins, 6 denotes the detection lever, 7 denotes the support member, and 8 denotes the intermediate guide lever, respectively as in the case of FIG. 2. The detection sliders 4a, 4b are guided by the guide portion disposed in the frame 9 so that they can slide in a right-to-left direction. When an outer peripheral edge of the small-diameter storage medium 30 being inserted comes into contact with the pins 5a, 5b disposed in extreme ends of the detection sliders 4a, 4b, the pins 5a, 5b are pressed and slid to the outside where they are separated from each other.

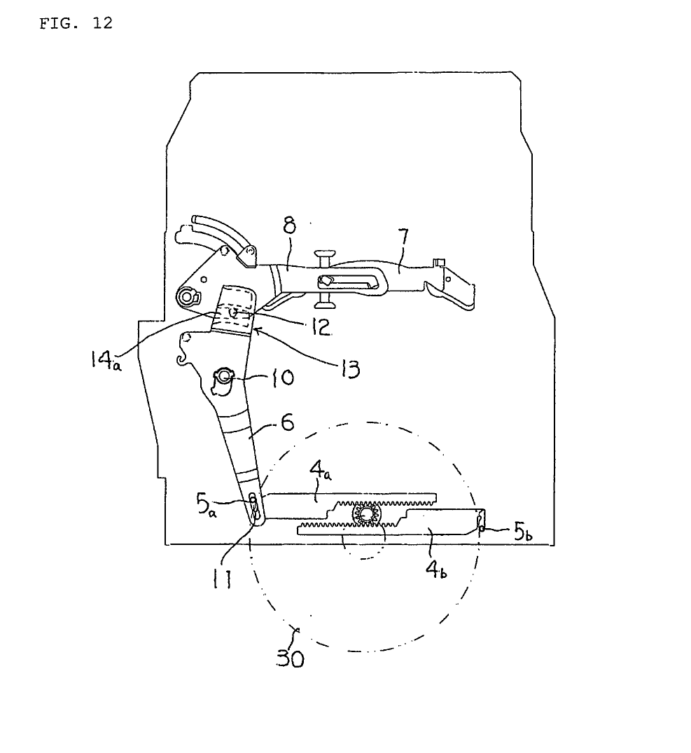

FIG. 12 is a schematic transparent plan view showing a state that the small-diameter storage medium 30 is further inserted into the apparatus than the state of FIG. 11. The detection sliders 4a, 4b slide to the outside along the outer peripheral edge of the small-diameter storage medium 30 and, at the same time, the detection lever 6 rotates clockwise about the shaft 10 as the fulcrum. The pin 5a, which is formed integrally with the detection slider 4a, is loosely fit into the long groove 11 formed in the extreme end of the detection lever 6, and if the pin 5a slides in an outer left direction together with the detection slider 4a, the detection lever 6 rotates clockwise.

The first projecting piece 12 is raised from the intermediate guide lever 8 and loosely fit into the select groove 14a formed in the other end 13 of the detection lever 6. When the small-diameter storage medium 30 is inserted, although the detection lever 6 rotates clockwise about the shaft 10 as the fulcrum, since it rotates at a small rotation angle, the first projecting piece 12 is not removed from the select groove 14a. In contrast, in the case of the large-diameter storage medium 3, since the detection lever 6 rotates at a large angle as shown in FIG. 3, the first projecting piece 12 is removed from the select groove 14a.

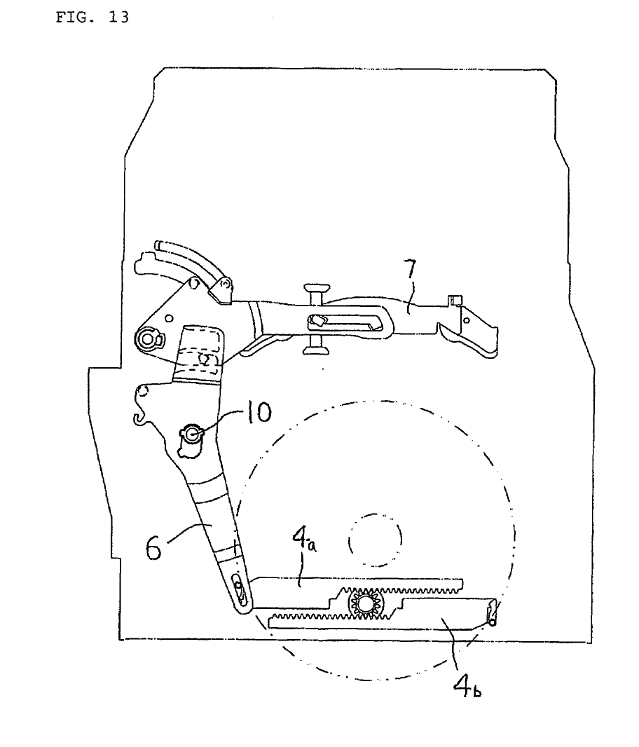

FIG. 13 is a schematic transparent plan view showing a state that the small-diameter storage medium 30 is further inserted into the apparatus than the state of FIG. 12. When more than half of an outside diameter of the small-diameter storage medium 30 is inserted into the recording/reproducing apparatus, the detection lever 6 rotates counterclockwise about the shaft 10 as the fulcrum as well as the detection sliders 4a, 4b slide in a direction where they approach each other while in contact with the outer peripheral edge of the small-diameter storage medium 30. However, in a state shown in FIG. 13, the outer peripheral edge of the small-diameter storage medium 30 being inserted does not come into contact with the support member 7 disposed in a rear portion of the recording/reproducing apparatus, and a certain degree of a gap remains therebetween.

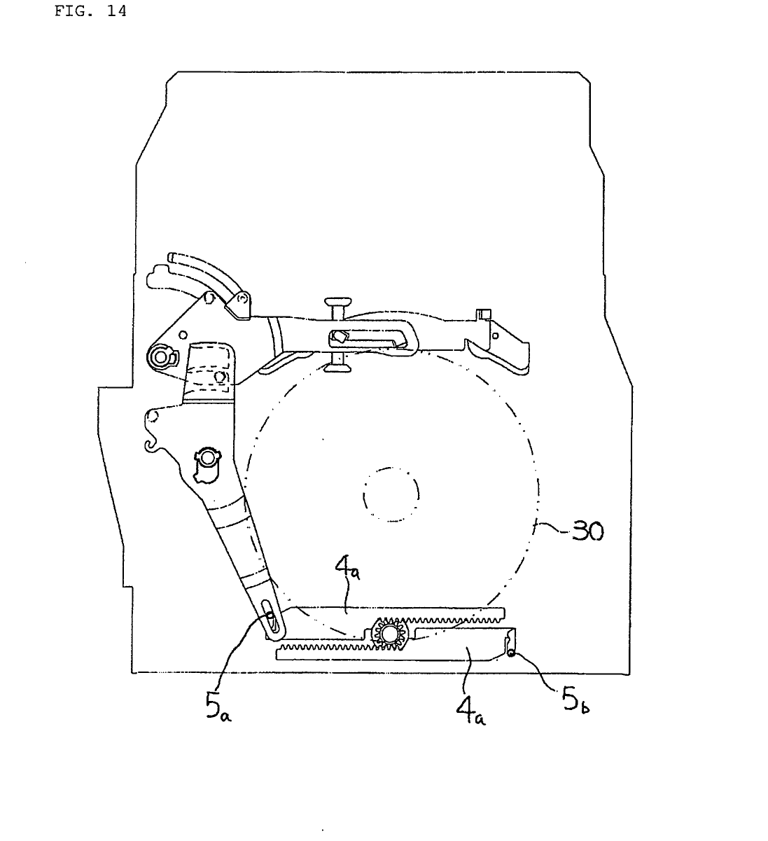

FIG. 14 is a schematic transparent plan view showing a state that the small-diameter storage medium 30 is further inserted into the apparatus than the state of FIG. 13. As shown in FIG. 14, the pins 5a, 5b formed in the ends of the detection sliders 4a, 4b are separated from the outer peripheral edge of the small-diameter storage medium 30. However, the small-diameter storage medium 30 is further carried into the recording/reproducing apparatus by a carrying roller (not shown) and a pressing member to be described later. Note that, since the carrying roller has a taper formed therein so that its diameter is reduced from ends toward a central portion, when the small-diameter storage medium 30 is carried in, it is moved toward the central portion. Even if, for example, the small-diameter storage medium 30 is inserted from an end of the storage medium insert port 1, it is carried toward the central portion in the recording/reproducing apparatus by the carrying roller having the above shape.

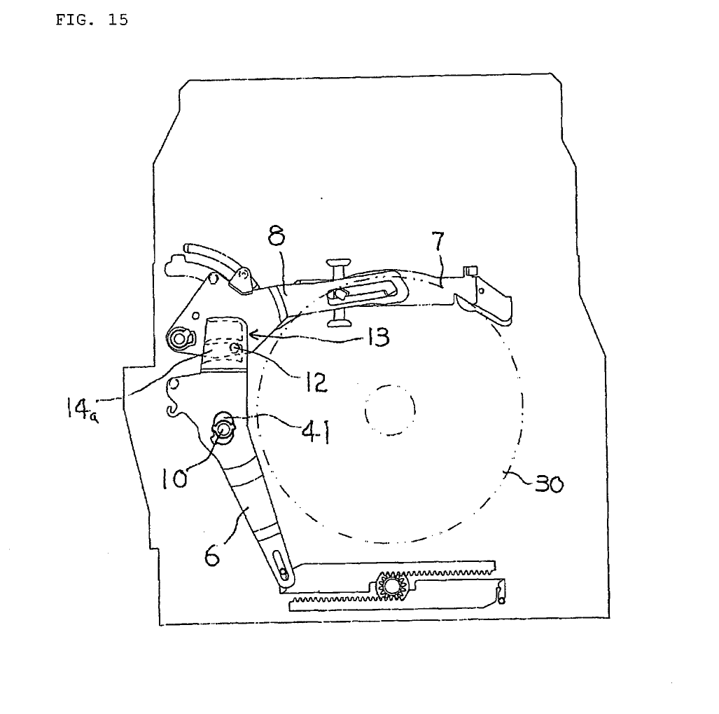

FIG. 15 is a schematic transparent plan view showing a state that the outer peripheral edge of the small-diameter storage medium 30, which is further carried into the recording/reproducing apparatus than the state of FIG. 14, comes into contact with the support member 7 and the support member 7 is slightly pressed and moved rearward as the small-diameter storage medium 30 is carried in and moved. The small-diameter storage medium 30 is moved to the rear side of the recording/reproducing apparatus by the carrying roller, and the support member 7 is pressed and retracted by the outer peripheral edge of the small-diameter storage medium 30. When the support member 7 is retracted, the intermediate guide lever 8 rotates counterclockwise about the shaft as the fulcrum, and since the first projecting piece 12 formed in the intermediate guide lever 8 is loosely fit into the select groove 14a, the detection lever 6 moves rearward.

A structure for moving the detection lever 6 rearward is approximately the same as that when the large-diameter storage medium 3 is inserted. More specifically, the first projecting piece 12, which is formed in the intermediate guide lever 8 by being raised therefrom, is loosely fit into the select groove 14a formed in the other end 13 of the detection lever 6, and the intermediate guide lever 8 rotates counterclockwise about the shaft as the fulcrum. As a result, the detection lever 6 is pulled rearward through the first projecting piece 12. Since a slot 41 is formed in a rotating fulcrum portion of the detection lever 6 and the shaft 10 is fit into the slot 41, the detection lever 6 can move within the range of the slot 41. The slider 19 is moved rearward as the detection lever 6 moves rearward, the rack gear 22 of the slider 19 is meshed with the gear 21, and the slider 19 is moved to the rear side of the recording/reproducing apparatus by the power of the drive motor approximately similarly to the operation for inserting the large-diameter storage medium 3 explained referring to FIGS. 9 and 10.

Note that a timing at which the slider 19 is slid by power of the drive motor and a timing at which the support member 7 is separated from the outer peripheral edge of a storage medium are different between the case where the large-diameter storage medium 3 is inserted and the case where the small-diameter storage medium 30 is inserted. More specifically, when the large-diameter storage medium 3 is inserted into the recording/reproducing apparatus, the detection lever 6 is pulled rearward and the rack gear 22 of the slider 19 is meshed with the gear 21 in a state that the first projecting piece 12, which is formed in the intermediate guide lever 8 by being raised therefrom, is loosely fit into the select groove 14b formed in the end 13 of the detection lever 6 as shown in FIGS. 6 and 7. Then, as shown in FIGS. 8 to 10, the third projecting piece 26 formed in the intermediate guide lever 8 is loosely fit into the select guide groove 25a formed in the rear end of the slider 19 which is moved to the rear portion of the recording/reproducing apparatus by the power of the drive motor, and the support member 7 is moved in a direction away from the outer peripheral edge of the large-diameter storage medium 3. In contrast, when the small-diameter storage medium 30 is inserted into the recording/reproducing apparatus, the detection lever 6 is pulled rearward and the rack gear 22 of the slider 19 is meshed with the gear 21 in a state that the first projecting piece 12 is loosely fit into the select groove 14a as shown in FIGS. 14 and 15. Although not shown, the third projecting piece 26 formed in the intermediate guide lever 8 is loosely fit into the select guide groove 25b formed in the rear end of the slider 19 which is moved to the rear portion of the recording/reproducing apparatus by the power of the drive motor, and the support member 7 is moved in a direction away from the outer peripheral edge of the small-diameter storage medium 30.

The difference between the structures corresponding to the storage media having different diameters is to cause the storage medium to securely reach a predetermined position in the recording/reproducing apparatus, i.e. a position at which the storage medium is clamped by the turntable and the damper and to cause the support member 7 having a holding function to be securely separated therefrom after the storage medium is clamped. In the embodiment, the structures are realized by the two types of the select grooves 14a, 14b, the two types of the select guide grooves 25a, 25b, and the first projecting piece 12 and the third projecting piece 26 loosely fit into the grooves at a less expensive cost without using an electric means.

Note that a means for clamping the small-diameter storage medium 30 by the turntable and the damper is the same as that when the large-diameter storage medium 3 is inserted. More specifically, the turntable attached to the traverse unit, which is tilted by the movement of the lateral slider 29 that is slid in association with the movement of the slider 19, lifts up the small-diameter storage medium 30 from a recording surface side thereof as well as clamps the small-diameter storage medium 30 together with the damper suspended by the damper suspension unit 2 at a confronting position. The small-diameter storage medium 30 lifted up by the turntable is separated from the carrying roller, and after the small-diameter storage medium 30 is clamped by the turntable and the damper, the parts such as the support member 7, which come into contact with the small-diameter storage medium 30, are separated from the outer peripheral edge thereof. As a result, information can be read from or written in the small-diameter storage medium 30 by the pick-up unit by rotating the storage medium by the turntable.

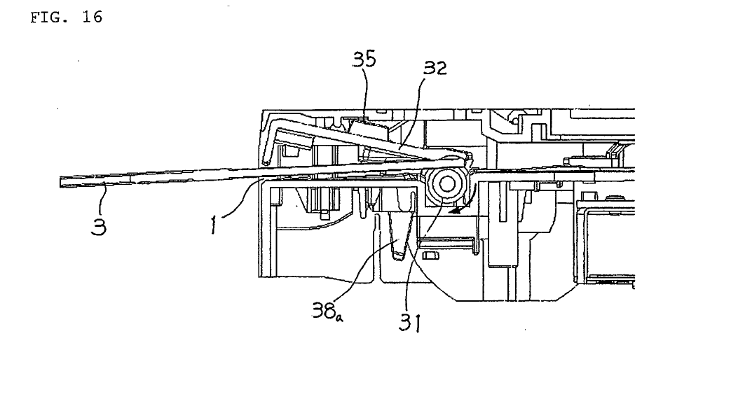

FIG. 16 is an internal longitudinal sectional view showing the vicinity of the storage medium insert port of the recording/reproducing apparatus of the embodiment. In FIG. 16, reference numeral 1 denotes the storage medium insert port, 3 denotes the large-diameter storage medium, 31 denotes a carrying roller, and 32 denotes a pressing member. The carrying roller 31 is disposed at a rear position of the storage medium insert port 1 and forms a thin rod member extending in parallel along the storage medium insert port 1. The carrying roller 31 has a taper formed therein so that its outside diameter is slightly reduced from both the ends toward a central portion. The large-diameter storage medium 3 inserted from the storage medium insert port 1 is placed on the carrying roller 31 and drawn into the recording/reproducing apparatus by the clockwise rotation (in an arrow direction) of the carrying roller 31. Moreover, since the carrying roller 31 has a taper formed slightly thinner from both the ends toward the central portion, even if the large-diameter storage medium 3, in particular the small-diameter storage medium 30 is inserted from an end side of the storage medium insert port 1, the storage medium can be moved toward the central portion while being carried in.

Incidentally, in a state that the large-diameter storage medium 3 is merely placed on the carrying roller 31 being rotated, there is a possibility that the large-diameter storage medium 3 slips on the carrying roller 31 and cannot be securely carried into the recording/reproducing apparatus. To cope with the above problem, the pressing member 32 is disposed at the position confronting the carrying roller 31 to press the large-diameter storage medium 3, which is inserted into the recording/reproducing apparatus, to the carrying roller 31 side. More specifically, the embodiment has such a structure that the carrying roller 31 is disposed at a lower position, which is the vicinity of the storage medium insert port 1 on the recording surface side of the large-diameter storage medium 3 inserted into the recording/reproducing apparatus, and the pressing member 32 is disposed at an upper position of the vicinity of the storage medium insert port 1 which is a position confronting the carrying roller 31. As a result, the pressing member 32 can carry the large-diameter storage medium 3, which is inserted from the storage medium insert port 1, into the recording/reproducing apparatus by pressing the large-diameter storage medium 3 from a display surface side to the carrying roller 31 side. Note that the pressing member 32 is mainly formed of a synthetic resin material taking it into consideration that it can be easily molded and that the large-diameter storage medium 3 and the like, which are inserted by the pressing member 32, are not scratched thereby.

An urging member is interposed between the pressing member 32 and the frame 9 in which the pressing member 32 is disposed to generate a pressing force to the carrying roller 31 side, and a torsion spring 35 is attached as the urging member in the embodiment. The pressing member 32 is pressed to the carrying roller 31 by the urging force of the torsion spring 35 at all times. As shown in the figure, the pressing member 32 is tilted about a shaft as a fulcrum by the urging force of the torsion spring 35 so that the pressing member 32 is made lower toward the carrying roller 31. Thus, the large-diameter storage medium 3, which is inserted from the storage medium insert port 1, can be securely carried into the recording/reproducing apparatus in a state that the large-diameter storage medium 3 is pressed toward the carrying roller 31 side by the pressing member 32, i.e., in a state that the large-diameter storage medium 3 is clamped by the carrying roller 31 and the pressing member 32.

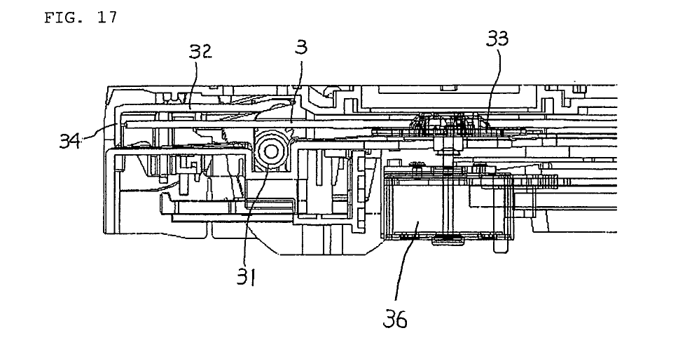

FIG. 17 is an internal longitudinal sectional view showing a state that the large-diameter storage medium 3 is lifted up by a turntable 33 at a predetermined position in the recording/reproducing apparatus. The turntable 33 is attached to the traverse unit. When the large-diameter storage medium 3, which is carried from the storage medium insert port 1 by the rotation of the carrying roller 31, reaches a predetermined position, the traverse unit in the tilt state tilts toward the damper side about one end as a fulcrum, and when the traverse unit is placed in an approximately horizontal state, the large-diameter storage medium 3 is lifted up by the turntable 33. To describe this in more detail, since the storage medium in the embodiment is a so-called disk-shaped storage medium having an approximately circular outside shape and a through hole formed in a central portion, the storage medium is lifted up by that a part of the turntable 33, which is tilted together with the traverse unit, is fit into the through hole of the storage medium. As shown in the figure, in the state that the large-diameter storage medium 3 is lifted up by the turntable 33, the large-diameter storage medium 3 is separated from the carrying roller 31. Then, the pressing member 32 is swung about the shaft as a fulcrum by a later-mentioned pressing means against the urging force so that the pressing member 32 is placed in an approximately horizontal state.

Incidentally, a shut-off portion 34 is formed in a front side (the storage medium insert port side) of the pressing member 32 and can close the storage medium insert port 1 by the pressing member 32 being swung so as to be made approximately horizontal. More specifically, when the large-diameter storage medium 3 is carried into the recording/reproducing apparatus and lifted up by the turntable 33, the pressing member 32 is swung so as to be made approximately horizontal against the urging force. As a result, a second storage medium can be prevented from being erroneously inserted from the storage medium insert port 1 by closing it by the shut-off portion 34. Information is read (reproduced) from and written (recorded) in the large-diameter storage medium 3 by rotating the large-diameter storage medium 3, which is lifted up by power of a rotation drive motor 36 coupled with the turntable 33 and by moving the pick-up unit disposed in the traverse unit orthogonally with respect to a rotating direction from the recording surface of the large-diameter storage medium 3. When the information is read from or written in the large-diameter storage medium 3 and it is carried out from the recording/reproducing apparatus, the traverse unit is lowered so as to be made to a tilt state about one end of the traverse unit as a fulcrum while the pressing member 32 is swung so as to be made from the horizontal state to the tilt state by the urging force. As a result, the shut-off portion 34 formed in the pressing member 32 moves upward from the state that the shut-off portion 34 closes the storage medium insert port 1, and can open the storage medium insert port 1.

Then, since the traverse unit tilts to be made to a tilt state about one end of the traverse unit as a fulcrum, the vicinity of the outer peripheral edge of the large-diameter storage medium 3 on its recording surface side comes into contact with the carrying roller 31 while the pressing member 32 applies a pressing force to the carrying roller 31 side from the display surface side of the large-diameter storage medium 3 by the urging force of the torsion spring 35. The carrying roller 31 is rotated counterclockwise (a direction opposite to an arrow) in a state that the large-diameter storage medium 3 is clamped by the carrying roller 31 and the pressing member 32 while the large-diameter storage medium 3 is pressed to the carrying roller 31 side by the pressing member 32, and the large-diameter storage medium 3 is carried out from the storage medium insert port 1.

Incidentally, although the large-diameter storage medium 3 is carried into and out from the recording/reproducing apparatus by the rotation of the carrying roller 31, a detection switch is mainly used to start and stop rotation of the carrying roller 31. In the embodiment, when the large-diameter storage medium 3 or the small-diameter storage medium 30 is carried, the detection switch is manipulated making use of sliding operations of the detection sliders 4a, 4b which come into contact with the outer peripheral edge of the storage medium. More specifically, the detection switch is disposed on sliding paths of the detection sliders 4a, 4b so that the switch can be turned on and off. To describe the embodiment in more detail, two detection switches, which can be turned on and off by being depressed by the detection slider 4b on one side, are disposed side by side on the sliding path of the detection slider 4b. More specifically, in the recording/reproducing apparatus of the embodiment, the storage medium can be securely carried in and out regardless of whether the large-diameter storage medium 3 or the small-diameter storage medium 30 is inserted.

When the large-diameter storage medium 3 or the small-diameter storage medium 30 is inserted from the storage medium insert port 1, the detection switch, which is disposed near the inside of the storage medium insert port 1 (hereinafter, called a detection switch A), of the two detection switches disposed side by side, is turned on by being depressed by the detection slider 4b which slides in contact with the outer peripheral edge of the storage medium, the drive motor begins to be rotated, and the carrying roller 31 begins to be rotated by the drive motor as a power source. Further, the detection switch A also relates to stop of the drive motor when the storage medium has been carried in. More specifically, the detection slider 4b, which turns on the detection switch A in response to insertion of the storage medium, slides along the outer peripheral edge of the storage medium. Thus, the detection slider 4b, which slides in a direction away from a central position of the storage medium insert port 1, returns to the central position and is turned off by being separated from the detection switch A once. Then, after the storage medium is clamped by the turntable 33 and the damper at the predetermined position as described above, the detection lever 6 is slightly rotated clockwise about the shaft 10 as the fulcrum by that the second projecting piece 24, which is loosely fit into the slide cam groove 23 formed in the slider 19, moves as the slider 19 slides. Then, the detection slider 4b is also slid in conformity with that the detection slider 4a, which is coupled with the detection lever 6 by the loosely fit pin 5a, slides in a direction slightly away from the central position of the storage medium insert port 1, and turns on by depressing the detection switch A again. At this time, the rotation of the drive motor is stopped, and the carrying roller 31, which uses the drive motor as the power source, is also stopped.

Next, a role of the detection switches when the storage medium is carried out from the recording/reproducing apparatus will be explained. When a button is depressed which relates to carrying-out of a storage medium and is included in manipulation buttons disposed on a display surface or the like of an electronic equipment in which the recording/reproducing apparatus of the embodiment is contained, the drive motor of the recording/reproducing apparatus begins to rotate in a direction opposite to that when the storage medium is carried in (counterclockwise described previously). Then, the storage medium clamped by the turntable 33 and the damper at the predetermined position in the apparatus is released from a clamped state by a downward tilt operation of the traverse unit and carried out to the storage medium insert port 1 by the carrying roller 31 using the drive motor as the power source. When the large-diameter storage medium 3 is carried out here, the detection switch A and a detection switch (hereinafter, called a detection switch B), which is disposed at a predetermined interval from the detection switch A, are turned on and off by the detection slider 4b which slides along the outer peripheral edge of the large-diameter storage medium 3. Further, when the small-diameter storage medium 30 is carried out, only the detection switch A is turned on and off by the detection slider 4b which slides along the outer peripheral edge of the small-diameter storage medium 30. These operations are performed due to a difference in diameter of the storage media to be carried out. That is, whether a storage medium to be carried out is the large-diameter storage medium 3 or the small-diameter storage medium 30 is detected according to states of the detection switches to be depressed, a timing at which the drive motor is stopped is adjusted according to types of the storage medium, and an amount of projection of the storage medium projecting from the storage medium insert port 1 is optimized.

When the large-diameter storage medium 3 is carried out, the detection switches A and B are depressed by the sliding operation of the detection slider 4b during a period in which the large-diameter storage medium 3 projects into the storage medium insert port 1 from a predetermined position in the recording/reproducing apparatus at which the storage medium is lifted by the turntable 33. To describe the operation in more detail, the large-diameter storage medium 3 whose clamped state is released in the recording/reproducing apparatus is pressed to the carrying roller 31 side by the pressing member 32 and carried out to the storage medium insert port 1 by the rotation of the carrying roller 31. The detection slider 4b, which comes into contact with the outer peripheral edge of the large-diameter storage medium 3 that is being carried out and moved, first depresses and turns on the detection switch A, and when the large-diameter storage medium 3 is further moved in a carry-out direction, the detection slider 4b also depresses and turns on the detection switch B following the detection switch A. More specifically, both the detection switches A and B are depressed and turned on in a state that the detection sliders 4a and 4b are most separated from each other by the large-diameter storage medium 3. When the large-diameter storage medium 3 is further carried out and moved from this state by the carrying roller 31, the detection sliders 4a and 4b move along the outer peripheral edge of the large-diameter storage medium 3 in a direction where they approach each other, the detection slider 4b is separated from the detection switch B, and the detection switch B is turned off. Since the drive motor is stopped when the detection switch A is turned on and the detection switch B is switched from a turned-on state to a turned-off state, the large-diameter storage medium 3 is stopped in a state that it partly projects from the storage medium insert port 1 appropriately. Therefore, the large-diameter storage medium 3 does not drop from the storage medium insert port 1.

In contrast, when the small-diameter storage medium 30 is carried out, only the detection switch A is depressed by the sliding operation of the detection slider 4b unlike when the large-diameter storage medium 3 is carried out. Since the small-diameter storage medium 30 is stopped in a state that it partly projects from the storage medium insert port 1 appropriately by stopping the drive motor when the detection switch A is switched from the turned-on state to the turned-off state, the small-diameter storage medium 30 does not drop from the storage medium insert port 1. From what has been described above, the embodiment has such a structure that the detection switches A and B are disposed on the carrying path of the detection slider 4b and the drive motor can be started and stopped according to an amount of movement of the detection slider 4b when the storage medium is inserted, and the drive motor can be stopped when the storage media having different diameters are carried out.

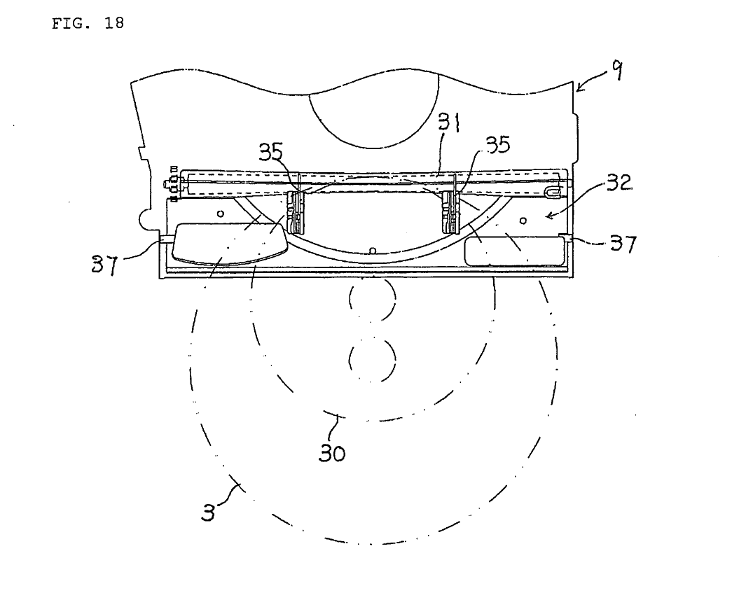

FIG. 18 is a schematic transparent plan view showing a state that the large-diameter storage medium 3 and the small-diameter storage medium 30 are partly inserted from the storage medium insert port 1. Note that although FIG. 18 shows a state that the large-diameter storage medium 3 overlaps the small-diameter storage medium 30, actually, only any one of the storage media is inserted. Incidentally, the shut-off portion 34 is formed in the front side (the storage medium insert port side) of the pressing member 32 and has an appropriately L-shaped cross section as described above. Then, shafts 37, 37 extend from both the ends of the pressing member 32 and journaled by the frame 9 of the recording/reproducing apparatus. Further, two torsion springs 35, 35 are attached between an upper portion of the pressing member 32 and the frame 9 and a uniform urging force is applied to the pressing member 32 in its entirety so that the pressing member 32 tilts toward the carrying roller 31 at all times.

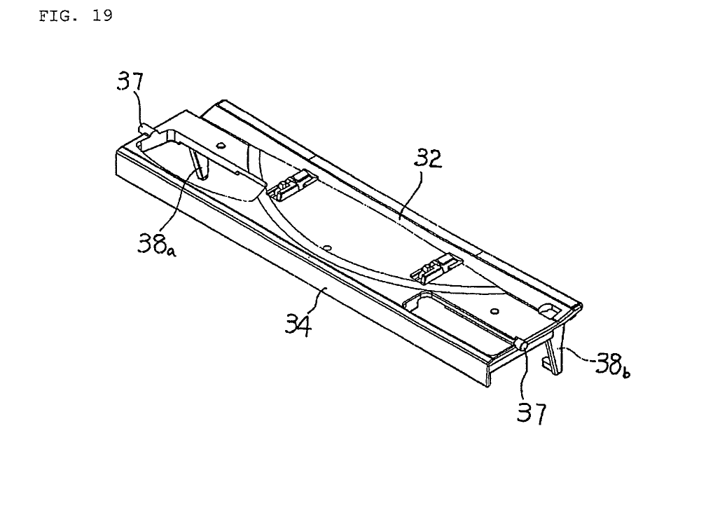

FIG. 19 is a perspective view showing a specific shape of the pressing member 32 in the embodiment. The shafts 37, 37 extend externally from both the ends of the pressing member 32, and arms 38a, 38b extend downward in the vicinity of both the ends. The pressing member 32 is journaled so as to be swung about the shafts 37, 37, and when the storage medium is carried in and out, the urging force of the torsion springs 35, 35 act on the pressing member 32 so that the pressing member 32 tilts about the shafts 37, 37 as fulcrums. Since the pressing member 32 is swung about the shafts 37, 37 as the fulcrums against the urging force of the torsion springs 35, 35 by pressing the arms 38a, 38b from a lower side by a pressing means, the shut-off portion 34 formed in the front side of the pressing member 32 moves downward and closes the storage medium insert port 1. Note that when the pressing means for the arms 38a, 38b is released, the pressing member 32 is swung about the shafts 37, 37 as the fulcrums in a direction where the shut-off portion 34 moves upward by the urging force of the torsion springs 35, 35 so that the storage medium insert port 1 is opened.

The pressing means of the embodiment will be explained using FIG. 9. The embodiment has such a structure that the sliding operations of the slider 19 and the lateral slider 29 are used as a means for pressing the arms 38a, 38b from a lower side. The rack gear 22, which is meshed with the gear 21, is formed in the slider 19 to transmit power of the drive motor, and FIG. 9 shows a state that the gear 21 is meshed with the rack gear 22 of the slider 19. A pressing member swing groove 39 is formed in the slider 19 approximately in parallel with the rack gear 22, and one of the arms 38a, 38b, i.e., the arm 38a, which extends downward from the pressing member 32, is loosely fit into the pressing member swing groove 39. Note that the arm 38a extends downward from a rear side of the pressing member 32. In contrast, in the figure, a pressing member swing groove 40 is also formed in a right extreme end of the lateral slider 29. The lateral slider 29 can move in a lateral direction in association with the sliding operation of the slider 19, and the other arm 38b, which extends downward of the pressing member 32, is engaged with the pressing member swing groove 40 by the sliding operation of the lateral slider 29.

The arm 38a of the pressing member 32 shown in FIG. 16 is loosely fit into the pressing member swing groove 39 formed in the slider 19 and positioned at a rear end thereof, and the other arm 38b is positioned in a location where it is not engaged with the pressing member swing groove 40 of the lateral slider 29. Thus, when the slider 19 slides rearward by the gear 21 being meshed with the rack gear 22, the arm 38a reaches an inlet side end of the pressing member swing groove 39 and is pressed upward and the lateral slider 29 moves rightward at the same time so that the other arm 38b is engaged with the pressing member swing groove 40 and holds the pressing member 32 in an approximately horizontal state. Accordingly, the arms 38a, 38b of the pressing member 32 are pressed from a lower side by the sliding operations of the slider 19 and the lateral slider 29, the pressing member 32 is swung against the urging force of the torsion springs 35, 35, and the storage medium insert port 1 is held in a state that it is closed by the shut-off portion 34 as shown in FIG. 17.

1. A storage medium reproducing apparatus or a storage medium recording/reproducing apparatus including a turntable, which allows a disk-shaped storage medium being inserted from a storage medium insert port disposed in a frame to be carried in by driving a carrying roller that is disposed in the vicinity of the storage medium insert port orthogonal to an insert direction of the storage medium and lifts up and rotates the disk-shaped storage medium being inserted at a predetermined position in the apparatus, a traverse unit being attached using the turntable as a main component, and a clamper for clamping the disk-shaped storage medium at a predetermined position in the apparatus together with the turntable, the storage medium reproducing apparatus or the storage medium recording/reproducing apparatus comprising:
a discriminating mechanism capable of discriminating whether the disk-shaped storage medium being inserted is a large-diameter storage medium or a small-diameter storage medium, carrying the discriminated disk-shaped storage medium from the storage medium insert port into the apparatus, and introducing the storage medium to a predetermined position in the apparatus where the storage medium can be clamped by the turntable and the damper,
wherein a pair of detection sliders is attached to the discriminating mechanism, the detection sliders having a pair of pins that come into contact with an outer peripheral edge of the storage medium being inserted in the vicinity of the storage medium insert port and sliding in a direction where the pins approach each other or are separated from each other along the outer peripheral edge of the storage medium, a detection lever, which has a long groove into which one of the pins formed in the detection sliders is loosely fit, is rotatably and slidably attached to a frame, a support member, with which the storage medium being inserted comes into contact and which can slide in the insert direction together with the storage medium, is attached in the apparatus, an intermediate guide lever, which is rotated about a shaft by a sliding operation of the support member, is coupled with the support member, a first projecting piece is disposed in the intermediate guide lever, and two select grooves, into which the first projecting piece can be selectively fit depending on the respective amounts of rotation of the detection lever and the intermediate guide lever, are formed in the detection lever.

2. The storage medium reproducing apparatus or the storage medium recording/reproducing apparatus according to claim 1, wherein a slider, which can slide approximately in parallel with the insert direction of the storage medium, is attached to the frame, a rack gear and a slide cam groove are formed in the slider, a pinion gear, which is meshed with the rack gear by a sliding operation of the slider, is disposed in the frame so that the pinion gear can be rotated by power of a drive motor, a second projecting piece, which is loosely fit into the slide cam groove, is disposed in the detection lever, and the rack gear is meshed with the pinion gear by sliding the detection lever by inserting the storage medium as well as slightly moving the slider through the second projecting piece to thereby slide the slider by the power of the drive motor.

3. The storage medium reproducing apparatus or the storage medium recording/reproducing apparatus according to claim 1, wherein two select guide grooves are formed in the slider, a third projecting piece, which is selectively fit according to a size of the storage medium being inserted and the sliding operation of the slider, is formed in the intermediate guide lever, and the support member is separated from the outer peripheral edge of the storage medium by rotating the intermediate guide lever through the third projecting piece which is fit into the select guide grooves just before the slider stops sliding when the storage medium has been inserted.

4. The storage medium reproducing apparatus or the storage medium recording/reproducing apparatus according to claim 2, wherein two select guide grooves are formed in the slider, a third projecting piece, which is selectively fit according to a size of the storage medium being inserted and the sliding operation of the slider, is formed in the intermediate guide lever, and the support member is separated from the outer peripheral edge of the storage medium by rotating the intermediate guide lever through the third projecting piece which is fit into the select guide grooves just before the slider stops sliding when the storage medium has been inserted.
